(19) United States
(12) Patent Application Publication
(10) Pub. No.: US 2009/0291598 A1
(43) Pub. Date: Nov. 26, 2009

(54) EARPHONE JACK ASSEMBLY AND A PORTABLE ELECTRONIC DEVICE USING THE EARPHONE JACK ASSEMBLY

(75) Inventors: CHAO-YUAN CHENG, Tu-Cheng (TW); CHAO-KUN TSENG, Tu-Cheng (TW); KAI-PO CHAN, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/331,555

(22) Filed: Dec. 10, 2008

(30) Foreign Application Priority Data
May 23, 2008 (CN) 200810301752.6

(51) Int. Cl. H01R 24/04

(52) U.S. Cl. 439/668

(57) ABSTRACT

An earphone jack assembly (40) using in a housing (30) of electronic device, the housing (30) includes a sidewall (32). The earphone jack assembly (40) includes earphone jack body (41), a fixing seat (42) and an earphone jack ring (43) latching to the sidewall (32). The earphone jack body (41) is received in the fixing seat (42) and abuts the earphone jack ring (43).

### BACKGROUND

1. Field of the Invention

The present invention relates to an earphone jack assembly and a portable electronic device having an earphone jack assembly.

2. Description of Related Art

Currently, electronic devices, such as mobile phones, radios, electronic dictionaries have an earphone jack. An earphone plug can be inserted into the earphone jack to transfer sound frequency signals to an earplug/headphone.

Referring to FIG. 4, a mobile phone includes a housing 10 and an earphone jack 20. The housing 10 has a frame 12 positioned on an inner surface thereof. The frame 12 and the housing 10 cooperatively define a receiving chamber 14. The housing 10 defines a hole 16 that communicates with the receiving chamber 14. The earphone jack 20 includes an earphone jack body 22 and a seat 24, wherein the seat 24 includes a through hole 26. An end of the seat 24 is integrally formed on the earphone jack body 22. When the earphone jack 20 is assembled, the seat 24 is inserted into the hole 16. The earphone jack body 22 is accommodated in the receiving chamber 14, with the through hole 26 communicating with the hole 16.

Due to the seat 24 is latched into the frame 12, a peripheral edge of the seat 24 cannot always be fully electro-plated. Therefore, when the housing 10 is electro-plated and the peripheral edge of the seat 24 is not fully electro-plated, the appearance of the device is degraded.

Therefore, there is room for improvement within the art.

### BRIEF DESCRIPTION OF THE DRAWINGS

FIG. 1 is a schematic, exploded view of a housing of mobile phone using an earphone jack assembly according to an exemplary embodiment.

FIG. 2 is a schematic, exploded view of an earphone jack body and a fixing seat.

FIG. 3 is a schematic, assembled view of FIG. 2.

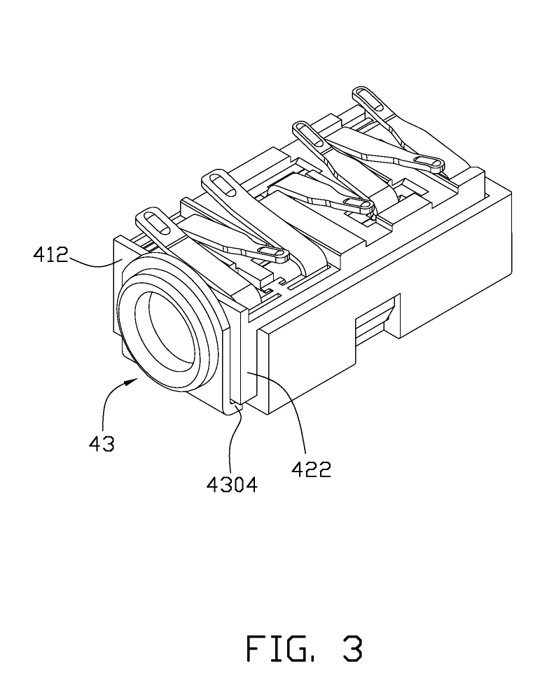

FIG. 4 is a schematic, exploded view of a housing of mobile phone using an earphone jack.

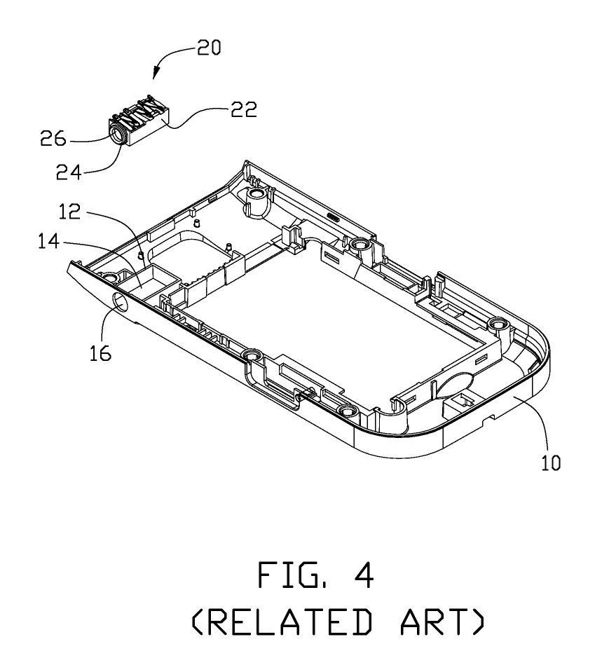

### DETAILED DESCRIPTION OF THE EXEMPLARY EMBODIMENTS

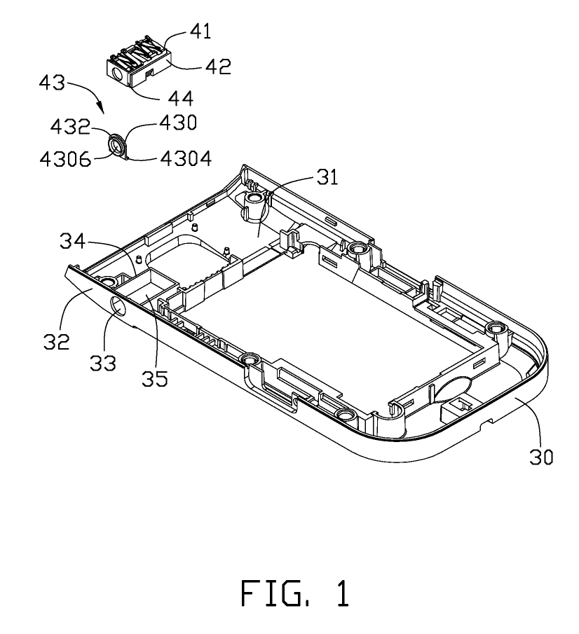

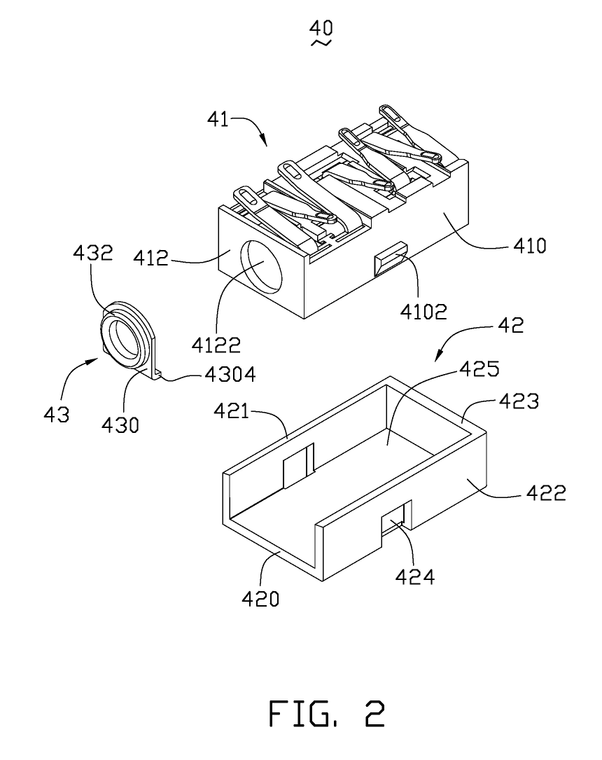

Referring to FIGS. 1 and 2 in an exemplary embodiment, an earphone jack assembly 40 is used in a housing 30 of a mobile device. The housing 30 has a bottom plate 31, a sidewall 32 extending from edges of the bottom plate 31, and a frame 34 connected to the bottom plate 31 and the sidewall 32. The sidewall 32 and the frame 34 cooperatively define a receiving cavity 35. The sidewall 32 defines a through hole 33 that communicates with the receiving cavity 35.

The earphone jack assembly 40 includes an earphone jack body 41, a fixing seat 42, and an earphone jack ring 43. The earphone jack body 41 is substantially rectangular and includes two sides 410 and two opposite end portions 412. Two latching portions 4102 are respectively positioned on the sides 410. One of the end portions 412 defines a plug socket 4122 configured to receive an earphone plug (not shown).

The fixing seat 42 includes a substrate 420, a left plate 421, a right plate 422 positioned opposite to the left plate 421, and an end plate 423. The substrate 420 is substantially rectangular and has a length smaller than the length of the earphone jack body 41. The left plate 421 and right plate 422 are respectively positioned on the two sides of the substrate 420. Each of the left plate 421 and right plate 422 defines an opening 424. Each of the latching portions 4102 can be inserted into the corresponding opening 424. The end plate 423, the left plate 421 and right plate 422 together define a chamber 425 configured for receiving the earphone jack body 41. The fixing seat 42 can be made of soft material, such as rubber and substrate 420, left plate 421, right plate 422 and end plate 423 can be integrally formed with. Thus, the fixing seat 42 can be formed to tightly engage with the earphone jack body 41.

The earphone jack ring 43 includes a main portion 430 and a flange portion 432 formed on the main portion 430. The main portion 430 has a bent edge 4304. The main portion 430 defines a hole 4306. The flange portion 432 surrounds the hole 4306. In the exemplary embodiment, the main portion 430 and the flange portion 432 can be integrally formed.

Also referring to FIG. 2, the latching portions 4102 are inserted into the openings 424. Accordingly, the earphone jack body 41 can be assembled in the chamber 425. Due to the length of the earphone jack body 41 being larger than the length of the substrate 420, when the earphone jack body 41 is mounted into the substrate 420, the earphone jack body 41 extends from the fixing seat 42 to form a protruding portion 44 (FIG. 1). The flange portion 432 is inserted into the through hole 33 and the earphone jack ring 43 abuts the sidewall 32. The fixing seat 42 and the earphone jack body 41 are assembled in the receiving cavity 35. The protruding portion 44 abuts the bent edge 4304. The end portion 412 abuts the earphone jack ring 43 and has a plug socket 4122 defined therein. As such, the earphone jack assembly 40 is assembled in the housing 30 of the mobile phone.

One of the advantages of the present earphone assembly is that, the earphone jack ring 43 can be detachably assembled on the earphone jack body 41 and separately electro-plated. Thus, the main portion 430 and the flange portion 432 can be fully electro-plated, producing a better and more attractive appearance of the earphone jack ring 43.

It is to be understood, however, that even through numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An earphone jack assembly for use in a housing of electronic device, the housing having a sidewall, the earphone jack assembly comprising:
an earphone jack body;
a fixing seat; and
an earphone jack ring abuting the sidewall;
wherein the earphone jack body is received in the fixing seat and abuts the earphone jack ring.

2. The earphone jack assembly as claimed in claim 1, wherein the sidewall defines a through hole, the earphone jack ring comprises a flange portion being latched into the through hole.

3. The earphone jack assembly as claimed in claim 2, wherein the earphone jack ring defines a hole, the flange portion surrounding the hole.

4. The earphone jack assembly as claimed in claim 3, wherein an end of the earphone jack ring has a bent edge, the earphone jack body extends from the fixing seat to form a protruding portion, the protruding portion abuts the bent edge.

5. The earphone jack assembly as claimed in claim 2, wherein the housing comprises a bottom plate, the sidewall extends from edges of the bottom plate, a frame is positioned on the bottom plate, the frame and the housing define a receiving chamber, the through hole is defined in the housing communicating the receiving chamber.

6. The earphone jack assembly as claimed in claim 2, wherein the earphone jack body comprises two opposite sides, each side having a latching portion, the fixing seat defines two opposite openings facing each other, the latching portions respectively insert into the openings.

7. The earphone jack assembly as claimed in claim 2, wherein the fixing seat comprises a substrate, a left plate, a right plate positioned at an opposite side of the left plate, and a end plate formed on the substrate, the end plate, the left plate and right plate define a chamber.

8. The earphone jack assembly as claimed in claim 7, wherein the earphone jack body is assembled in the chamber.
